(19) United States
(12) Patent Application Publication
(10) Pub. No.: US 2024/0428077 A1
(43) Pub. Date: Dec. 26, 2024

(54) REFINING DIGITAL TWIN TO IMPROVE PHYSICAL ENTITY

(71) Applicant: INTERNATIONAL BUSINESS MACHINES CORPORATION, ARMONK, NY (US)

(72) Inventors: Peng Hui Jiang, Beijing (CN); Jun Su, Beijing (CN); Dong Hui Liu, Beijing (CN); Jia Yu, Beijing (CN); Hua Wang, Newton, MA (US); QING XIE, Beijing (CN)

(21) Appl. No.: 18/337,501

(22) Filed: Jun. 20, 2023

(51) Int. Cl. G06N 3/086

(52) U.S. Cl. CPC G06N 3/086

(57) ABSTRACT

A method, computer system, and a computer program product for digital twin usage are provided. A first digital twin and performance data of the first digital twin are input into a first machine learning model to produce a second digital twin. The first machine learning model performs neural network-based data clustering. The first and second digital twins digitally represent a first physical entity. The second digital twin includes one or more changes from the first digital twin. Performance data of the second digital twin is analyzed. In response to the analysis indicating a problem with the second digital twin, implementation of the second digital twin is revoked and the first digital twin is reimplemented

### BACKGROUND

The present invention relates to the fields of computers, artificial intelligence, and digital twins that digitally represent a physical entity and that can help with entity evolvement and simulation. A digital twin is a virtual copy of a physical product, process, or system. Digital twins have been used to store attribute information and records of previous states of the attributes related to a physical entity.

### SUMMARY

According to one exemplary embodiment, a method for digital twin usage is provided. According to the method, a first digital twin and performance data of the first digital twin are input into a first machine learning model to produce a second digital twin. The first machine learning model performs neural network-based data clustering. The first and second digital twins digitally represent a first physical entity. The second digital twin includes one or more changes from the first digital twin. Performance data of the second digital twin is analyzed. In response to the analysis indicating a problem with the second digital twin, implementation of the second digital twin is revoked and the first digital twin is reimplemented. A computer system and computer program product corresponding to the above method are also disclosed herein.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is an operational flowchart illustrating a digital twin refining process according to at least one embodiment;

FIG. 2 illustrates aspects of at least one embodiment of a physical entity and a digital twin that digitally represents the physical entity;

FIG. 3 is another operational flowchart illustrating another digital twin refining process according to at least one embodiment;

FIG. 4A is another operational flowchart illustrating aspects of data collection and processing that according to at least one embodiment are involved in the digital twin refining processes described earlier;

FIG. 4B illustrates aspects of data clustering that according to at least some embodiments are involved in the digital twin refining processes described earlier;

FIG. 5 is another operational flowchart illustrating aspects of data analytics and modelling that according to at least one embodiment are involved in the digital twin refining processes described earlier;

FIG. 6 is another operational flowchart illustrating aspects of a model prediction and refinement loop that according to at least one embodiment is involved in the digital twin refining processes described earlier;

FIG. 7 is another operational flowchart illustrating aspects of prediction result selection that according to at least one embodiment is involved in the digital twin refining processes described earlier;

FIG. 8 is a pipeline illustrating aspects of modelling and simulation that according to at least one embodiment are involved in the digital twin refining processes described earlier;

FIG. 9 is a pipeline illustrating aspects of digital twin optimization and refinement that according to at least one embodiment are involved in the digital twin refining processes described earlier;

FIG. 10 illustrates a state transition version graph of representations of various digital twins which according to at least one embodiment is involved in the digital twin refining processes described earlier; and

FIG. 11 is a block diagram illustrating a computer environment with multiple computer systems in which the digital twin refining process described in the other drawings may be implemented.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

According to one exemplary embodiment, a method for digital twin usage is provided. According to the method, a first digital twin and performance data of the first digital twin are input into a first machine learning model to produce a second digital twin. The first machine learning model performs neural network-based data clustering. The first and second digital twins digitally represent a first physical entity. The second digital twin includes one or more changes from the first digital twin. Performance data of the second digital twin is analyzed. In response to the analysis indicating a problem with the second digital twin, implementation of the second digital twin is revoked and the first digital twin is reimplemented. A computer system and computer program product corresponding to the above method are also disclosed herein.

In this manner, an enhanced way of providing a prediction for a digital twin enhancement is achieved that allows for using the changed digital twin for earlier testing. These techniques help achieve enhanced entity evolvement and better leverage historical states and previous iterations of digital twins for design and development. The digital twin enhancements help lead to real world physical entity improvement and enhancement. Improved responsiveness to mis-prediction is achieved to better the entity evolvement. Iterative feedback may be achieved that helps the design and development process.

In some additional embodiments, the second digital twin and performance data of the second digital twin are input into the first machine learning model to produce a third digital twin. The third digital twin digitally represents the first physical entity and includes one or more changes from the second digital twin. Performance data of the third digital twin is analyzed. In response to the analysis of the performance data of the third digital twin indicating a problem with the third digital twin, implementation of the third digital twin is revoked and the second digital twin is reimplemented.

In this manner, an enhanced way of providing a prediction for a digital twin enhancement is achieved that allows for using the changed digital twin for earlier testing. These techniques further help achieve enhanced and more sophisticated entity evolvement and better leverage historical states and previous iterations of digital twins for design and development. The digital twin enhancements help lead to real world physical entity improvement and enhancement. Improved responsiveness to mis-prediction is harnessed to better the entity evolvement. Iterative feedback may be achieved that helps the design and development process.

In some additional embodiments, the second digital twin and performance data of the second digital twin are input into the first machine learning model to produce a third digital twin. The third digital twin digitally represents the first physical entity and includes one or more changes from the second digital twin. The first machine learning model produces one or more additional digital twins that include a respective digital representation of the first physical entity. A state transition version graph representing the first, the second, the third, and the one or more additional digital twins is produced. Performance data of the third digital twin is analyzed. In response to the analysis of the performance data of the third digital twin indicating a problem with the third digital twin, implementation of the third digital twin is revoked and another of the first, second, and one or more additional digital twins is implemented. Selecting of the other digital twin for the implementation is based on navigating the state transition version graph.

In this manner, visual graphical depictions of digital twin versions representing a single base physical entity are leveraged to achieve improved responsiveness to digital twin mis-prediction and to better guide machine learning prediction for digital twin enhancements. Iterative feedback may be achieved that helps the design and development process.

In some additional embodiments, navigating the state transition version graph includes selecting a nearest digital twin symbol along a branch of the third digital twin or selecting a digital twin symbol from another branch next to a branch of the third digital twin.

In this manner, visual graphical depictions of digital twin versions representing a single base physical entity are leveraged to find more similar digital twin versions for reimplementation to reduce the evolutional impact of a single mis-prediction by a machine learning model.

In some additional embodiments, based upon the second digital twin having a highest confidence score, the first machine learning model selects the second digital twin amongst multiple proposed digital twins for output in response to the inputting.

In this manner, data analytics and modelling techniques are harnessed to achieve improved prediction for digital twin enhancements.

In some additional embodiments, an alteration command to alter the first physical entity to match the second digital twin is transmitted.

In this manner, achievement of a real world effect of a physical entity is facilitated in response to experimentation using a digital twin that represents the physical entity.

In some additional embodiments, a clustering algorithm is applied to the performance data of the first digital twin to identify clusters and outliers. The clusters and not the outliers are input into the first machine learning model.

In this manner, data analytics and modelling techniques are harnessed to achieve improved prediction for digital twin enhancements.

In some additional embodiments, a clustering algorithm is applied to the performance data of the first digital twin to identify clusters that are input into the first machine learning model. At least one of the clusters includes an enhanced feature for inputting into the first machine learning model. The enhanced feature includes a combination of at least two data types of the performance data of the first digital twin.

In this manner, data analytics and modelling techniques are harnessed to achieve improved prediction for digital twin enhancements.

In some additional embodiments, performance data of the first digital twin is generated via inputting of the first digital twin to a simulation program.

In this manner, automated experimentation is harnessed to better evaluate potential improvements to a physical entity in the real world.

In some additional embodiments, the first machine learning model is trained by inputting evolved entity families of other physical entities to an initial machine learning model.

In this manner, other successful techniques from developing entities from other fields and/or families are harnessed and shared for improving predictions in other fields of physical entities.

In some additional embodiments, performance data of the digital twin includes digital sensor readings, digital component data, and/or user feedback.

In this manner, digital tools in a simulation environment are harnessed to better evaluate potential improvements to a physical entity in the real world.

In some additional embodiments, the one or more changes of the second or changed digital twin include a change of an operating condition of the first digital twin, a change of location of one or more elements of the first digital twin, an addition of one or more new elements that are not present in the first digital twin, and/or a removal of one or more elements of the first digital twin.

In this manner, a variety of potential modifications are used in digital experimentation to better evaluate potential improvements that could be made to a physical entity in the real world.

The following described exemplary embodiments provide a computer-implemented method, a computer system, and a computer program product for refining digital twins. Digital twins may be predicted and optimized. The present embodiments include generating a digital twin model that digitally represents a physical entity. Data is measured and extracted from the physical entity and is used to generate the digital model. The data reveals relationships of components of the physical entity. The digital twin is set-up to have digital components which digitally interact with each other to reflect the relationships of the components of the physical entity. The present embodiments help manage the life cycles of digital twins including with their initiation, design and development, verification and validation, deployment, operation and monitoring, and reassessment and decommissioning. The present embodiments help manage the life cycle of the physical entities represented by digital twins including verification and validation, deployment, operation and monitoring, reassessment and decommissioning, recycling, and re-use.

The present embodiments include collecting data on the performance of an entity, such as sensor readings, device data, and user feedback. The data may be transmitted using telemetry. The data is analyzed to identify patterns and trends and to build models that capture the behavior and performance of the entity. The present embodiments include retrospection of the history, grasping the present, and predicting the future in the digital twin with the assistance of machine learning. Machine learning is used to predict enhancements of the digital twin, and, therefore, enhancements of the physical entity that the digital twin represents. Some embodiments include developing machine learning models with algorithms that can predict future behavior of a physical entity that is being represented in the digital twin. In at least some embodiments, automated construction of one or more state transition version graphs depicting different versions of digital twins within a single physical entity family occurs. Of the various digital twins, different weights are assigned according to their occurrence possibility. Some embodiments include running simulations and/or other tests to evaluate the machine learning-proposed system/object enhancement and to verify that the predicted enhanced digital twin operates in an improved manner or to achieve improved results. In some embodiments these simulations are part of model validation in which the accuracy and reliability of suggestions received from the machine learning model are validated. The use of the digital twin can help with the model validation to ensure digital twin and entity updates are effective and that the machine learning model provides effective suggestions. The state transition version graph may be used to automatically evaluate and predict new potential versions of the digital twin. Machine-generated digital twin enhancements may be applied to the digital twin under examination in order to better evaluate and optimize the new proposal. Iterative feedback may be provided for design and development of the digital twin and, therefore, of the design and development of the physical entity represented by the digital twin. The present embodiments include an automated roll back to a previous version of the digital twin if the new version of the digital twin is found to have compatibility issues or other problems.

Machine learning is a branch of artificial intelligence (AI) and computer science which focuses on the use of data and algorithms to imitate the way that humans learn, gradually improving its accuracy. Neural networks, or artificial neural networks (ANNs), include node layers, containing an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed along to the next layer of the network by that node. Deep learning may include multiple layers in a neural network. A neural network that consists of more than three layers-which would be inclusive of the input and the output—can be considered a deep learning algorithm or a deep neural network. A neural network that only has three layers may be referred to as a basic neural network. Deep learning and neural networks are credited with accelerating progress in areas such as computer vision, natural language processing, and speech recognition. The present embodiments improve a training process for a machine learning model.

Supervised learning, also known as supervised machine learning, is defined by its use of labeled datasets to train algorithms to predict helpful modifications. As input data is fed into the machine learning model, the machine learning model adjusts its weights until the machine learning model has been fitted appropriately. Model fitting occurs as part of the cross validation process to ensure that the model avoids overfitting or underfitting. Some structures and/or methods used in supervised learning include neural networks, naïve bayes, linear regression, logistic regression, random forest, and support vector machine (SVM).

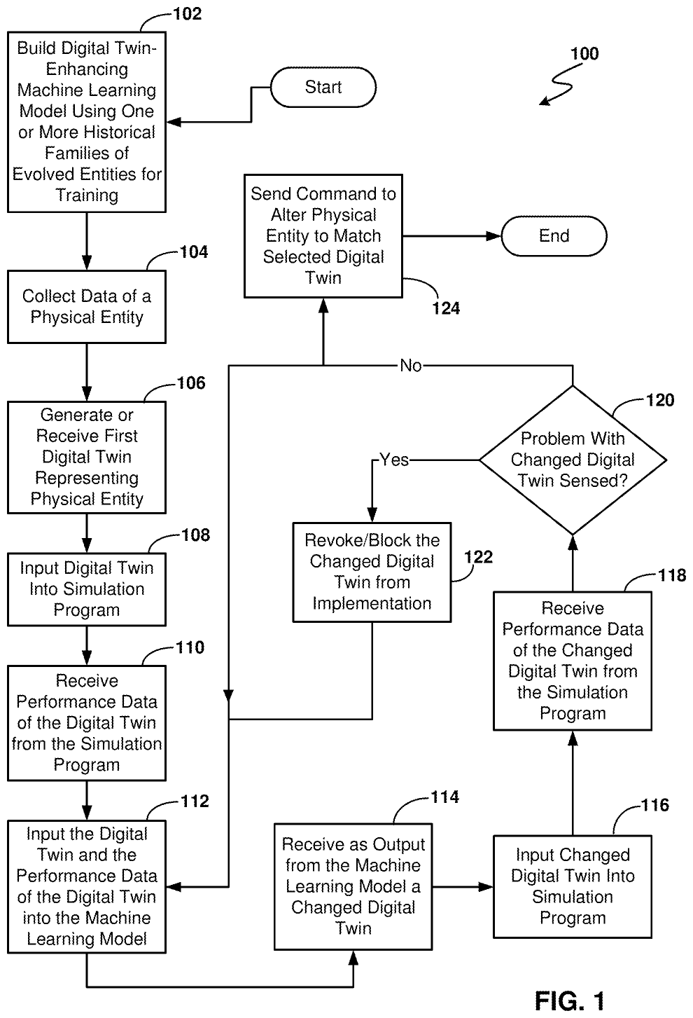

Referring now to FIG. 1, an operational flowchart is shown that illustrates a digital twin refining process 100 according to at least one embodiment.

In step 102 of the digital twin refining process 100 shown in FIG. 1, a digital twin-enhancing machine learning model is built using one or more historical families of evolved entities for training. The one or more historical families of evolved entities may be represented via digital representations of the various members of each respective historical family. For example, for evolved entities with a first-generation entity, a second-generation entity, a third-generation entity, etc., respective digital representations of each of those entities may be input into an initially untrained or pre-trained machine learning model. The digital representations may be input without labels. Alternatively, the digital representations may be input with labels so that the training of the machine learning model occurs in a supervised manner. The various generations may be referred to as a version 1.0, a version 2.0, a version 3.0, etc. The labelling of the versions facilitates tracking and managing the different versions. The historical families of evolved entities may encompass entities of various types such as vehicles, computers, machines, buildings, structural portions of buildings, software systems, functional systems of buildings, etc. Training the machine learning model with entities from a variety of entity family types results in a more robust machine learning model that is able to subsequently generate a variety of digital twin refinement suggestions for enhancing the digital twin and the entity itself.

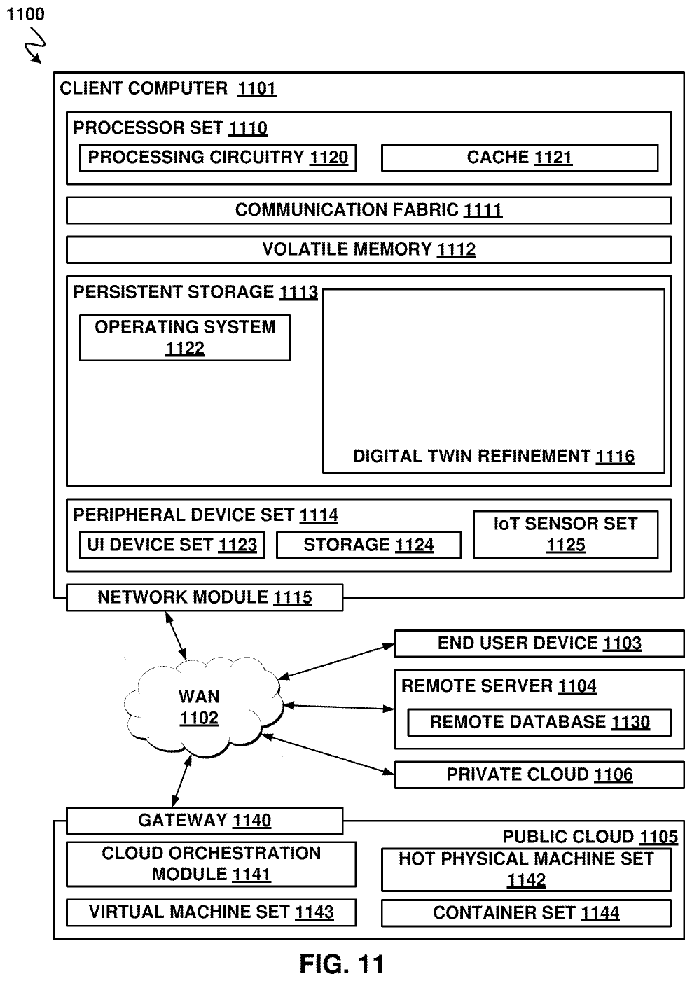

As part of step 102, the digital twin refinement program 1116 (depicted in FIG. 11) may receive one or more files containing information about the historical families of evolved entities which are to be used to train the machine learning model. A computer such as the client computer 1101 hosting the digital twin refinement program 1116 may receive an uploaded file which contains specifications of the families of evolved entities. In at least one embodiment, the obtaining of step 102 includes receiving digital files via a transmission over a communication network such as the wide area network 1102 that is shown in FIG. 11. The digital twin refinement program 1116 itself may encompass the machine learning model and/or may communicate with another computer such as a remote server 1104 which hosts the machine learning model to be trained.

A machine learning model trained in step 102 includes neural network models and additionally may include other aspects such as naive Bayes models, random decision tree models, linear statistical query models, logistic regression n models, convolutional neural networks, multi-layer perceptrons, residual networks, long short-term memory architectures, algorithms, deep learning models, deep learning generative models, and other models. The learning algorithm, in training the machine learning models in question, finds patterns in input data in order to map the input data attributes to the target modification suggestion. The trained machine learning models contain or otherwise utilize these patterns so that the recommendations can be predicted for similar future inputs. The machine learning model uses the patterns that are identified to determine what the appropriate modification suggestion(s) are for future data to be received and analyzed. As samples are being provided, training of the one or more machine learning models may include supervised learning by submitting prior data sets to an untrained or previously trained machine learning model. In some instances, unsupervised and/or semi-supervised learning for the one or more machine learning models may also be implemented.

In step 104 of the digital twin refining process 100 shown in FIG. 1, data of a physical entity is collected. The digital twin refinement program 1116 may receive a file containing information about the physical entity for which a digital twin is to be created and/or maintained. A computer such as the client computer 1101 hosting the digital twin refinement program 1116 may receive an uploaded file which contains a specification of physical and operational details about the entity. A manufacturer and/or a supplier of the physical entity or of components of the physical entity may generate such a specification-containing file. One or more sensors able to communicate with the client computer 1101 and/or with another computer may also capture information about the physical entity and its respective components which are sent to the digital twin refinement program 1116 and/or another digital twin-building program. Such sensors may use/include cameras, transmitters/receivers, sound waves, and/or any other tool to capture information and/or to perform measurements about the physical entity and its components. The information may be gathered before the physical entity is in operation and/or while the physical entity is in operation. The physical entity itself may contain one or more computers such as IoT sensors which collect data and transmit the data to a digital twin-building/maintaining program. In at least one embodiment, the obtaining of step 102 includes receiving digital files via a transmission over a communication network such as the wide area network 1102 that is shown in FIG. 11.

In step 106 of the digital twin refining process 100 shown in FIG. 1, a first digital twin representing the physical entity is generated or received. The physical entity of step 106 refers to the physical entity from which data was collected in step 104. The digital twin refinement program 1116 itself may encompass a digital twin creation engine and/or may communicate with another computer such as a remote server 1104 which hosts a digital twin creation engine which is a software module which receives, as input, system and/or component information and/or specifications and, in response, produces, as output, a digital twin that digitally represents the physical entity. The digital twin that is generated or received may be stored in data memory associated with and/or accessible to the digital twin refinement program 1116, e.g., in the persistent storage 1117 and/or in a remote database 1130. For a digital twin that was already created, step 106 occurs with the receiving of that digital twin, e.g., by the receiving at client computer 1101 and/or digital twin refinement program 1116 of a digital file in which the information for the digital twin is contained. The digital file may be transmitted from one computer to the client computer 1101 over a network such as the wide area network 1102.

The digital twin generated and/or received in step 106 is a virtual copy of the physical entity. The physical entity may, for example, be a physical product, process, and/or system. The digital twin acts as a bridge between the real physical world and the virtual digital world. Sensors may be used to collect real-time data about physical items. The collected real-time data may be used to build and/or update the digital twin. Through the real-time sensing, connection mapping, precise analysis, and/or immersive interaction the digital twin describes the physical system, realizes the fusion of virtual and real complex systems, and may be used to predict and control the physical systems and to achieve maximum closed-loop optimization of all elements, processes, and value chains of the physical entity/system. Digital twins may, depending on the field of usage, be divided into a component level and/or a system level. The digital twin may be divided into a historical state, a real-time state, and/or a future state based on space-time characteristics of the digital twin and/or the physical entity represented by the digital twin. The digital twin may be divided into a design state, a manufacturing state, and/or a running state. The digital twin helps with managing a full life cycle of a physical entity that is represented by the digital twin. Different industries and fields build digital twins of different levels, different temporalities, and/or different states according to their focus and to meet the changing requirements of a full life cycle management of physical entities in different industries.

In step 108 of the digital twin refining process 100 shown in FIG. 1, the digital twin is input into a simulation program. The digital twin refers to the digital twin that was generated or received in step 106. The simulation program is a software module that is part of or accessible to the digital twin refinement program 1116. The simulation program is programmed to include standard operating conditions for the physical entity that is digitally represented by the digital twin. The simulation program runs with the digital twin as an input and indicates the simulated performance of the physical entity at various operating conditions. The operating conditions applied vary from higher ranges to lower ranges based on predicted and/or previously experienced conditions. The simulation program is based on identified patterns, trends, and component dynamics of the physical entity and its components. The performance data is stored in computer memory that is with and/or accessible to the digital twin refinement program 1116. That computer memory may include the persistent storage 1113 and/or computer memory in a remote location such as at the remote server 1104.

In step 110 of the digital twin refining process 100 shown in FIG. 1, performance data of the digital twin is received from the simulation program. Step 108 described above included the digital twin being input into the simulation program. This inputting caused the simulation of the digital twin performing in various operating conditions to occur. This simulation produced performance data which was saved by the simulation program. The performance data may be saved in computer memory that is with and/or accessible to the digital twin refinement program 1116. That computer memory may include the persistent storage 1113 and/or computer memory in a remote location such as at the remote server 1104. The receiving of step 110 may include the passing of the performance data from memory elsewhere within the client computer 1101 to the digital twin refinement program 1116. Additionally or alternatively, the receiving of step 110 may include a transmission of one or more digital files containing the performance data from memory elsewhere via the wide area network 1102 to the client computer 1101 and to the digital twin refinement program 1116. For example, the performance data may be stored at computer memory of the remote server 1104 and be transmitted to the client computer 1101 and the digital twin refinement program 1116 via the wide area network 1102. In at least some embodiments, the performance data includes digital sensor readings, digital component data, and/or user feedback. In other words, these readings and data are from sensors or other computers that exist digitally in a simulation.

In at least some embodiments, the digital twin refining process 100 also includes steps of evaluating the physical entity information to ascertain an entity type of the physical entity. Then, the machine learning model that was trained in step 102 is further trained with information and/or knowledge that are specific to the entity type. These steps may include the digital twin refinement program 1116 using the internet to perform automated research with respect to the entity type and web scraping information associated with the entity type. The digital twin refinement program 1116 may store a digital dictionary associated with the entity type to help guide the web scraping. The digital twin refinement program 1116 in some embodiments also performs vector generation and semantic similarity analysis of online information in order to evaluate relevancy to an entity type. Information found to be relevant is scraped and fed into the machine learning model.

In step 112 of the digital twin refining process 100 shown in FIG. 1, the digital twin and the performance data of the digital twin are input into the machine learning model. The machine learning model refers to the digital twin-enhancing machine learning model that was built in step 102. The digital twin was that digital twin generated or received in step 106. The performance data is the performance data that was received in step 110 regarding the simulation of the performance of the digital twin in the simulation program. This machine learning model may for example be hosted at the client computer 1101 or at another computer accessible to the client computer 1101. The inputting of step 112 may include a transmission along an internal bus of the client computer 1101 or an external transmission via the wide area network 1102 to an external computer that hosts the machine learning model such as the remote server 1104. The internal and/or external transmission may be of one or more digital files which contain the digital twin and the performance data of the digital twin.

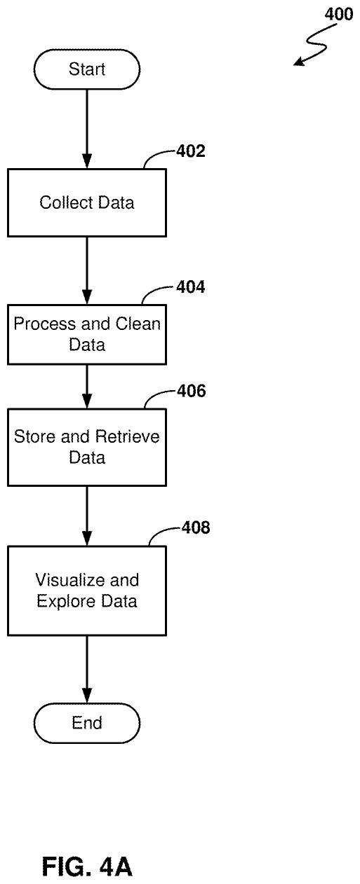

In at least some embodiments before the performance data of the digital twin is input into the machine learning model in step 112, a clustering algorithm is applied to the performance data to identify clusters and outliers within the performance data. The clusters and not the outliers are input into the machine learning model. In at least some embodiments, at least one of the clusters includes an enhanced feature for inputting into the machine learning model. The enhanced feature includes a combination of at least two data types of the performance data of the digital twin. FIG. 4B illustrates aspects about such clustering.

In step 114 of the digital twin refining process 100 shown in FIG. 1, a changed digital twin is received as output from the machine learning model. This output is generated in response to step 112 occurring, namely in response to the inputting of the digital twin and the performance data into the machine learning model. For the first iteration through the digital twin refining process 100, the changed digital twin produced and received in step 114 is a second digital twin (compared to the first digital twin that was generated or received in step 106). In subsequent iterations through the digital twin refining process 100, the changed digital twin produced and received in step 114 is a third digital twin, a fourth digital twin, a fifth digital twin, etc. The digital twin produced and received in step 114 includes one or more changes from the digital twin that was input into the machine learning model in step 112. Despite the one or more changes, the digital twin produced and received in step 114 shares many features and elements with the digital twin that was input into the machine learning model in step 112. In instances when the iteration produces a third digital twin in step 114, the third digital twin includes one or more changes from the second digital twin that was input into the machine learning model in step 112. To produce the output, the machine learning model performs neural network-based data clustering.

For the neural network-based data clustering performed by the machine learning model, the machine learning model itself performs clustering directly. In at least one embodiment, the machine learning model includes autoencoders which learn a compressed representation of the data and then provide the compressed representation to inner layers of the machine learning model. This compression is helpful especially when the data that is input is high-dimensional. After the compression, the machine learning model applies a clustering algorithm to the compressed data. For analyzing high-dimensional data, the clustering algorithm may be less effective unless the high-dimensional data is compressed before the clustering algorithm is applied.

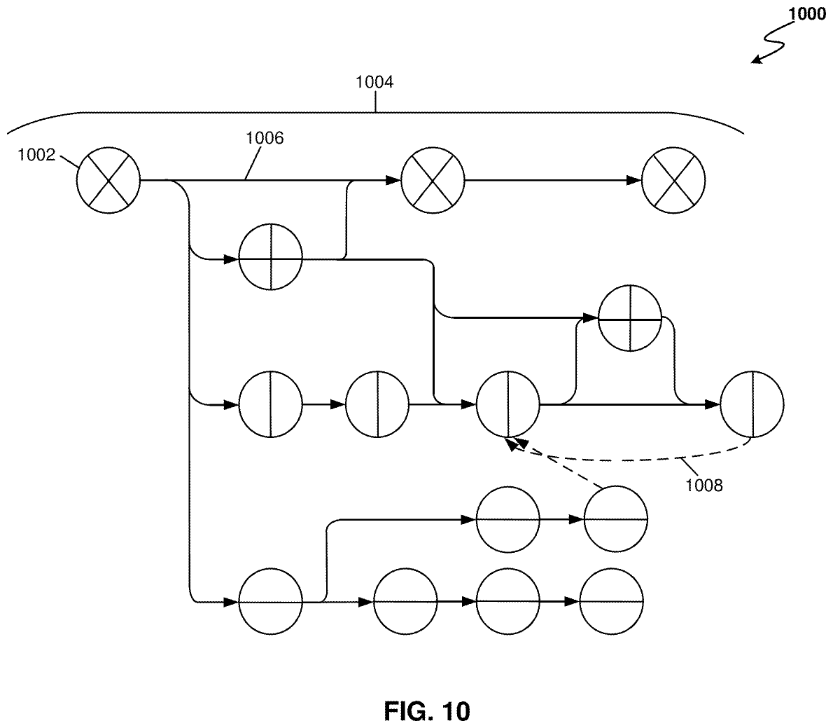

Also as part of producing the output, in at least some embodiments the machine learning model generates a state transition version graph that illustrates multiple possible digital twins as candidates for being selected as the changed digital twin. The machine learning model assigns respective weights to the multiple possible digital twins based on occurrence possibility of the respective possible digital twin. The machine learning model selects the changed digital twin from amongst the multiple possible digital twin based on a highest occurrence possibility. FIG. 10 and the discussion of same provides details about features of the state transition version graph which is implemented by the machine learning model in these embodiments.

In step 116 of the digital twin refining process 100 shown in FIG. 1, the changed digital twin is input into the simulation program. This changed digital twin refers to the digital twin that was received in step 114 as the output of the machine learning model. This simulation program used in step 116 is the same simulation program that was used in steps 108 and 110 to gather performance data about the initial or first digital twin. The simulation program is a software module that is part of or accessible to the digital twin refinement program 1116. The simulation program is programmed to include standard operating conditions for the physical entity that is digitally represented by the changed or second digital twin. The simulation program runs with the changed or second digital twin as an input and indicates the simulated performance of the physical entity (that corresponds to the changed or second digital twin) at various operating conditions. The operating conditions applied vary from higher ranges to lower ranges based on predicted and/or previously experienced conditions. The performance data is stored in computer memory that is with and/or accessible to the digital twin refinement program 1116. That computer memory may include the persistent storage 1113 and/or computer memory in a remote location such as at the remote server 1104.

In step 118 of the digital twin refining process 100 shown in FIG. 1, performance data of the changed digital twin is received from the simulation program. This receiving of step 118 occurs in response to the inputting that occurred in step 116. The simulation program is the same program involved in steps 108, 110, and 116. The receiving of performance data in step 118 is analogous to the receiving of the performance data that occurred in step 110 albeit the performance data is generated from the changed or second digital twin instead of from the initial or first digital twin.

The receiving of step 118 occurs in response to the inputting of step 116. The inputting of step 116 caused the simulation to occur of the changed or second digital twin performing in various operating conditions. This simulation produced performance data which was saved by the simulation program. The performance data may be saved in computer memory that is with and/or accessible to the digital twin refinement program 1116. That computer memory may include the persistent storage 1113 and/or computer memory in a remote location such as at the remote server 1104. The receiving of step 118 may include the passing of the performance data from memory elsewhere within the client computer 1101 to the digital twin refinement program 1116. Additionally or alternatively, the receiving of step 118 may include a transmission via a wireless network such as WAN 1102 of one or more digital files containing the performance data from memory elsewhere to the client computer 1101 and to the digital twin refinement program 1116. For example, the performance data may be stored at computer memory of the remote server 1104 and be transmitted to the client computer 1101 and the digital twin refinement program 1116 via the wide area network 1102. In at least some embodiments, the performance data of the changed or second digital twin includes digital sensor readings, digital component data, and/or user feedback.

In step 120 of the digital twin refining process 100 shown in FIG. 1, a determination is made as to whether a problem is sensed concerning the changed digital twin. If the determination of step 120 is affirmative in that a problem is sensed concerning the changed digital twin, the digital twin refining process 100 proceeds to step 122. If the determination of step 120 is negative in that no problem is sensed concerning the changed digital twin, the digital twin refining process 100 proceeds to steps 112 and 124. For the path through step 112, a repeat of steps 112, 114, 116, 118, and 120 occurs with respect to another digital twin to be generated. Thus, the steps 112, 114, 116, 118, and 120 may constitute a loop to repeatedly produce enhanced and/or refined digital twins.

For the determination of step 120, the performance data that is received in step 118 may be input into another machine learning model which as output provides a problem evaluation of the changed digital twin or the second digital twin. This other machine learning model may be trained to compare performance data for effectively operating digital twins and physical entities with ineffectively operating digital twins and physical entities. When the difference between the performance data and acceptable performance exceeds a pre-determined threshold, this other machine learning model produces a determination that the changed or second digital twin is problematic. The machine learning model may be trained with the performance data received in step 110, from any actual performance data of the physical entity that is digitally represented by the various digital twins, and from information and/or knowledge that is specific to the field of the entity. In some embodiments, the digital twin refinement program 1116 performs automated web scraping to obtain such information and/or knowledge that is specific to the field of the entity.

In at least some embodiments, the additional machine learning model implemented in step 120 provides as output a performance level that may be a numerical value. The numerical value may be compared against a numerical value representing an effective level of performance. This comparison may produce a difference value. The difference value may be compared against a threshold value, e.g., a pre-determined threshold value, to determine whether the changed or second digital twin is problematic. If the difference is below the threshold level, the process 100 proceeds to steps 124 and 112. If the difference is equal to or above the threshold level, the process proceeds to step 122. The determination of step 120 may include the use of a comparator that is part of the digital twin refinement program 1116. The comparator is configured to perform a numerical comparison of the differences and the threshold value. The user may pre-determine the threshold level. The user may adjust the threshold level by interacting with a graphical user interface generated by the digital twin refinement program 1116. Such interactions may occur via the user providing input via an input device such as a keyboard, a mouse/mouse pad, and/or a microphone connected to the computer 1101 to adjust the threshold level. In some embodiments, the digital twin refinement program 1116 may use training from other trained machine learning models (trained with the experiences of other users) to determine a threshold level. In one example, a performance level is generated on a scale of 0 to 100 with 0 being a lowest performance and 100 being a highest performance. The threshold level in one embodiment may be 45 on the range of 0 to 100 and that threshold level may be adjusted by the user.

In step 122 of the digital twin refining process 100 shown in FIG. 1, the changed digital twin is revoked/blocked from implementation. In at least some embodiments, this revoking occurs with respect to the physical entity which is digitally represented by the various digital twins. Thus, the changes that were part of the changed or second digital twin would not be implemented in the physical entity that is digitally represented by the digital twins. If the changes that were part of the changed or second digital twin has already been implemented in the physical entity that is digitally represented by the digital twins, a command would be sent to have those changes reversed in the physical entity. In at least some embodiments, the revoking/blocking additionally or alternatively refers to usage of the digital twins in the simulation programs. In response to a changed digital twin being problematic, the digital twin refinement program 1116 ends the digital implementation of that version, reimplements a previous version of the digital twin, and then proceeds back for a repeat of the step 112 to generate a new additional proposed changed digital twin that may constitute a refinement of the original or previous digital twins. For example, in response to the analysis indicating a problem with the second digital twin, implementation of the second digital twin would be revoked and the first digital twin would be reimplemented. In another example, in response to an analysis of the performance data of a third digital twin indicating a problem with the third digital twin, implementation of the third digital twin is revoked and the second digital twin is reimplemented. In response to the analysis of performance data of a third digital twin indicating a problem with the third digital twin, in some embodiments implementation of the third digital twin is revoked and another of first, second, and one or more additional digital twins is implemented. In some embodiments, selecting of the other digital twin for the implementation/reimplementation after the revocation is based on navigating a state transition version graph.

In step 124 of the digital twin refining process 100, a command is sent to alter the physical entity to match the selected digital entity. In at least some embodiments the command occurs in the form of a presentation to a user so that the user may then manually adjust the physical entity to match the selected digital twin. This presentation in at least some embodiments includes a transmission of a message such as a textual and/or audio message that would be presented and/or played for a user. The message may be displayed on a display screen of the client computer 1101 and/or played on an audio speaker of the client computer 1101. In some embodiments, a digital file containing the message is transmitted externally from the client computer 1101 via the wide area network 1102 for presentation at some other computer that may be more accessible to a user who is predicted to implement the physical entity change. For example, the message may be transmitted to another end user device 1103. In some embodiments, if an alteration command for the physical entity has already been sent and then a problem with that version is identified, the alteration command is revoked so that the physical entity returns to its previous version.

In some embodiments in which the digital twin refinement program 1116 has access to digitally control operational aspects of the physical entity, the command of step 124 additionally or alternatively takes the form of digital instructions sent to a controller of the physical entity. The digital instructions cause the controller to adjust the operating conditions according to the changes that occurred for the changed or second digital twin.

In some embodiments in which the changes include addition of new components for the physical entity, the command of step 124 includes automation of acquisition of the new component. This automation may include automated engagement of an online transaction to order and obtain such new component from a supplier of the component. In some instances, a confirmation prompt may be generated, transmitted to, and presented for a user to engage with to confirm that such new component is to be obtained.

In some embodiments, performance data of a changed, e.g., a second, digital twin is generated via inputting of the changed digital twin to a simulation program. The performance data produced by the simulation program is validated by comparing the performance data of the changed, e.g., second, digital twin to performance data of the first physical entity that was altered to match the changed, e.g., second, digital twin. Thus in this embodiment, performance data of the altered physical entity is captured and stored. The physical entity is used for usual operation and/or unusual operation (e.g., in extreme conditions) in order to gather this performance data.

After step 124, the digital twin refining process 100 may end or may be repeated via the loop back to steps 112, 114, 16, 118, and/or 120. Via repeated iterations, branches and families of digital twins may be created to allow improved experimentation into possible changes that would benefit the physical entity.

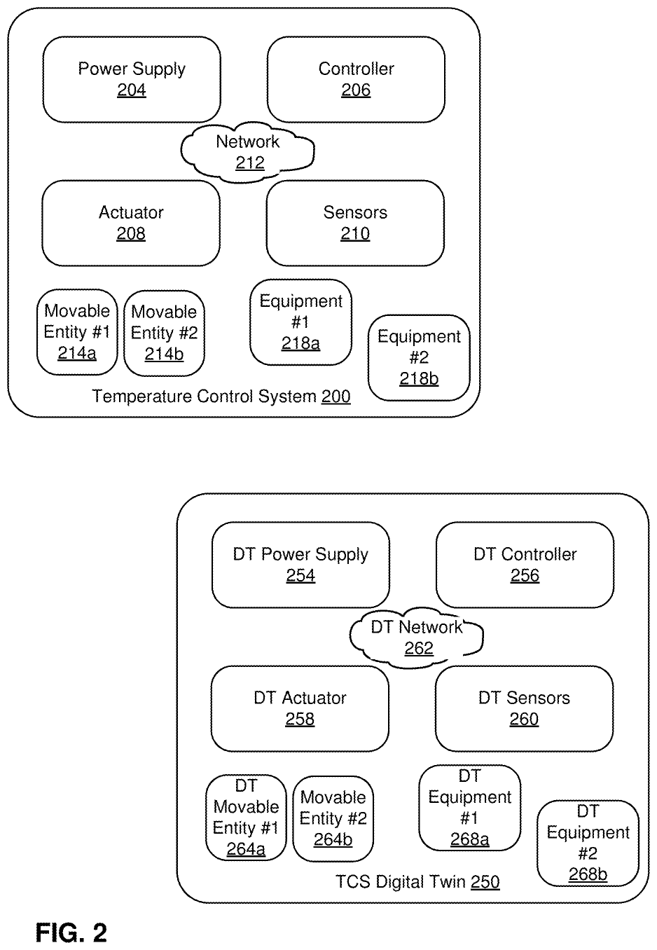

FIG. 2 illustrates aspects of a physical entity and a digital twin that digitally represents the physical entity. Specifically, FIG. 2 shows a temperature control system 200 and a temperature control system (TCS) digital twin 250 that digitally represents the temperature control system 200. For the various components and elements of the temperature control system 200, the TCS digital twin 250 includes data, logic, and/or digital information to represent each of the various components and elements. The temperature control system 200 includes a power supply 204, a controller 206, an actuator 208, and sensors 210 such as thermostats, thermometers, etc. The power supply 204, the controller 206, the actuator 208, and the sensors 210 communicate with each other via data transmissions through a network 212 that may be a local or a wide area network. The TCS digital twin 250 includes a DT (digital twin) power supply 254, a DT controller 256, a DT actuator, and DT sensors 260 which digitally represent the power supply 204, the controller 206, the actuator 208, and the sensors 210, respectively. The DT network 262 digitally represents the network 212. The DT network 262 is able to digitally simulate the wired and/or wireless data transmissions between the components.

The temperature control system 200 also includes first and second movable entities 214a, 214b which for example may represent people and/or other objects within the environment of the temperature control system 200. These entities affect the temperature within the environment and, therefore, the operation of the temperature control system 200. The temperature control system 200 also includes first and second equipment 218a, 218b to represent other equipment that is part of and/or within the environment of the temperature control system 200.

The TCS digital twin 250 also includes first and second DT movable entities 264a, 264b which digitally represent the first and second movable entities 214a, 214b, respectively. The TCS digital twin 250 also includes first and second DT equipment 268a, 268b to digitally represent the first and second equipment 218a, 218b of the temperature control system 200.

This TCS digital twin 250 and the temperature control system 200 are examples of the digital twins and physical entity referred to in the digital twin refinement process 100 described above and shown in FIG. 1.

Various factors affect the temperature control system 200. Such factors include ambient temperature, air conditioning set temperature, air conditioning power, number of air conditioners, distance between air conditioners, power supply, number of temperature sensors, space distance between temperature sensors, number and type of air quality detection sensors, space distance between air quality sensors, personnel density, and device density. Building design and/or materials such as insulative materials can also affect the temperature control system 200.

A digital twin such as the TCS digital twin 250 is a virtual representation of a physical object, system or other asset such as the temperature control system 200. The digital twin tracks changes to the physical entity (which may be a physical object, system or asset) across the lifespan of the entity and records the changes as they occur. A digital twin includes a complex virtual model that is a digital model counterpart to the physical entity that exists in real space. Sensors and internet-of-things (IoT) devices connected to the physical entity collect data, often in real-time. The collected data can then be mapped to the virtual model of the digital twin. An individual with access to the digital twin can see the real-time information about the physical entity operating in the real world without having to be physically present and without having to view the physical entity while it operates. Rather, users such as engineers can use the digital twin to understand not only how the physical entity is performing, but to predict how the physical entity may perform in the future, using the collected data from sensors. IoT devices, and other sources of data and information being collected. Moreover, digital twins can help manufacturers and providers of physical entities with information that helps the manufacturer understand how customers continue to use the products after the purchasers have acquired the physical entity.

As physical entities such as the temperature control system 200 change over time, through modifications, updates, wear, tear, damage, etc., digital twins mimic the changes to accurately reflect the changes that have been made to the physical entity over time. Real-time feeds from sensor devices, IoT devices, recording devices, and/or other data collection systems capture performance information that is output by physical entities and monitor performance changes as a result of variations to configuration, design, components, and/or maintenance of a physical entity. The real-time data collection that is applied and/or presented in the digital twin allows users of the digital twin, such as owners, operators, and engineers, to predict future issues that may arise, to solve functionality problems, to optimize entity performance, and to simulate changes to the physical entity before implementation.

Owners, operators, and engineers of physical entities can use digital twins to diagnose problems within a physical entity or to optimize entity configurations to achieve peak performance. Such users may leverage customizable digital twin simulation configurations to achieve more accurate identification of potential improvements and more effective problem solving. Thus, digital twins can help overcome entity problems which hamper physical entity performance or limit peak performance of the physical entity.

FIG. 2 shows a temperature control system but the principles of the digital twin representing a physical entity as described herein apply to other types of physical entities and their digital twins.

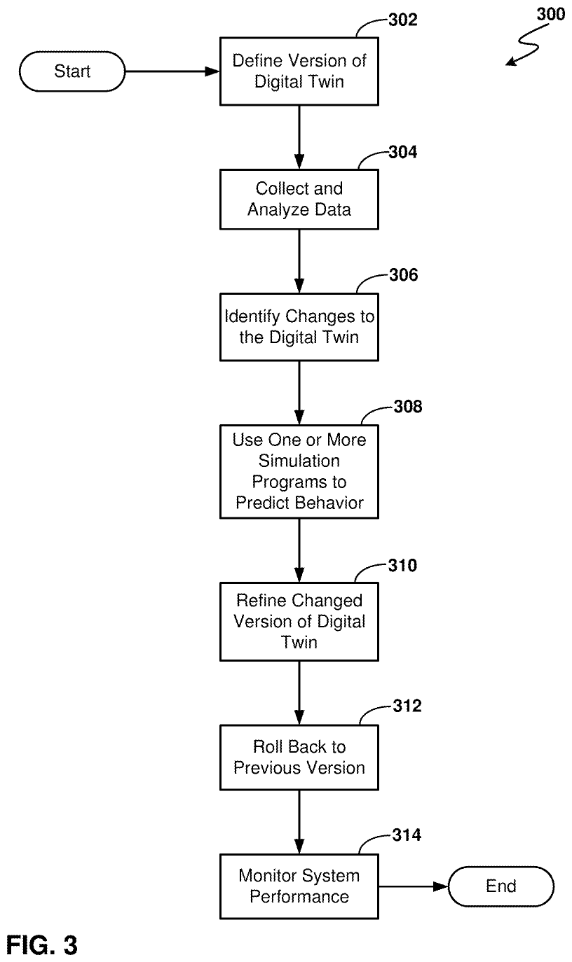

FIG. 3 illustrates another operational flowchart illustrating another digital twin refining process 300 according to at least one embodiment. In the other digital twin refining process 300, a version of a digital twin is defined in step 302, data is collected and analyzed in step 304, changes to the digital twin are identified in step 306, one or more simulation programs are used to predict behavior in step 308, the changed version of the digital twin is refined in step 310, a roll back to a previous version occurs in step 312, and system performance is monitored in step 314.

In the step 302 of the other digital twin refining process 300, one or more versions of a digital twin are defined. Each version of the digital twin is identified with a unique identifier to allow it to be distinguished from other versions of the digital twin which represent the same base physical entity. For example, in some embodiments the identifier for a first version of the digital twin would be “Version 1.0”, the identifier for a second version of the digital twin would be “Version 2.0”, etc. For subsequent iterations of the other digital twin refining process 300, in some embodiments the identifier for the new digital twin version created is Version N+1 with N being the identifier for the digital twin version of the previous iteration.

In the step 304 of the other digital twin refining process 300, data is collected and analyzed. In some embodiments this data is collected from simulations performed on the one or more digital twins that were defined in step 302. The digital twin is input to a simulation program that is part of and/or accessible to the digital twin refinement program 1116. In some embodiments, this step 304 additionally or alternatively includes data collection from the physical entity that is digitally represented by the respective one or more digital twins. Sensor readings, data collection devices, and/or user feedback are part of the data collection of step 304. This data may be collected by sensors connected to the client computer 1101 or may be transmitted with telemetry to the client computer 1101 or another computer. The data is analyzed to identify patterns and trends and to learn the dynamics of the entity and its components. Those patterns, trends, and dynamics are used to build one or more simulation programs that capture the behavior and performance of the digital twin and the entity. FIG. 4A also describes additional aspects of the data collection of step 304 as well as of the data collection of steps 104, 108, 110, 116, and/or 118 of the digital twin refining process shown in FIG. 1 and discussed earlier. The data collection of step 304 of the other digital twin refining process 300 shown in FIG. 3 includes some overlap with the data collection of steps 104, 108, 110, 116, and/or 118 of the digital twin refining process 100 shown in FIG. 1.

In step 306 of the other digital twin refining process 300, changes to the digital twin are identified. Once a new digital twin version is created, the new digital twin is compared to one or more of the previous digital twin versions in the family in order to identify changes to operating conditions and/or any new components that the new digital twin has that is not found in the previous digital twins. In at least some embodiments, the new/changed digital twin is produced via a machine learning model. The comparison to identify the changed and/or new aspects may be performed in an automated manner via the digital twin refinement program 1116. The digital twin refinement program 1116 may include a data comparator which compares the digital data of each digital twin to identify new and/or changed portions. Any updated or new components or software for the changed digital twin are in some embodiments evaluated to determine and evaluate their impact on the performance of the digital twin and the physical entity. In the digital twin refining process 100 shown in FIG. 1, a change identification step corresponding to step 306 in some embodiments takes place between the steps 114 and 116. After the new/changed digital twin is received as output in step 114, the change identification takes place before the new/changed digital twin is input into the simulation program in step 116.

In step 308 of the other digital twin refining process 300, one or more simulation programs are used to predict behavior in step 308. The simulation programs that were developed in step 304 are used to predict the behavior and performance of a new/changed digital twin. The simulation program(s) run one or more simulations and/or other tests to identify operational improvements and/or digression for the changed digital twin. Therefore, this simulation helps determine whether the machine learning model is successful in providing helpful suggestions for improving the physical entity. This step 308 includes at least some overlap with the steps 116 and 118 in the digital twin refining process 100 shown in FIG. 1, meaning that the description provided above for steps 116 and 118 also may apply to step 308 in at least some embodiments.

In step 310 of the other digital twin refining process 300, the changed version of the digital twin is refined. This refinement of step 310 may include optimization of the new/changed digital twin. This refinement is based on the information gleaned from the simulation of step 308. If the simulation shows a worrisome change in one system element, step 310 includes adjusting the digital twin to compensate for that change. For example, if the simulation indicates that new software is causing higher power consumption, step 310 includes adjusting the software to reduce power usage. In at least some embodiments, the potential refinements are accessed in a troubleshooting lookup table that is stored in data storage part of or otherwise accessible to the digital twin refinement program 1116. Therefore, in some embodiments the refinement adjustments of step 310 are performed in an automated manner for the changed digital twin. In some embodiments, this step 310 is added for the digital twin refining process of FIG. 1 as a direct loop from step 120 back to step 116 in response to step 120 finding a problematic digital twin. The loopback allows the adjusted/refined digital twin to be tested in simulations again in repeat of steps 116 and 118 before the digital twin is blocked from implementation. If the adjustments pass the determination of step 120 within a pre-determined number of iterations, this digital twin base is preserved. If the adjustments do not pass the determination of step 120 within a pre-determined number of iterations, this digital twin base is revoked/blocked in step 122 and the machine learning model is used to generate another suggestion for changing the digital twin.

In step 312 of the other digital twin refinement process 300, a roll back to a previous version occurs. If the changed version is found to have compatibility issues or other problems that are not rectifiable via the refinement of step 310, the digital twin refinement program 1116 rolls back the digital twin usage to the prior version of the digital twin usage. Choosing a version for the rollback is described more with the state transition version graph described in FIG. 10. In some embodiments, the version chosen for the rollback is that version that was implemented immediately prior to the rejected version before steps 112 and 114 in the recent iteration occurred. The explanation provided above for the roll back of step 122 of the digital twin refining process 100 of FIG. 1 also applies for step 312.

In step 314 of the other digital twin refining process 300, system performance is monitored. After the digital twin has been updated and tested, the digital twin is monitored for performance. Issues are identified and addressed. For embodiments in which the physical entity is adjusted to match the changed digital twin, step 314 also includes the monitoring of the performance of the physical entity as well as of the performance of the digital twin. This monitoring of step 314 when applied to the digital twin refining process 100 shown in FIG. 1 may occur following step 124 in some embodiments. Alternatively, this monitoring of step 314 when applied to the digital twin refining process 100 shown in FIG. 1 may occur immediately prior to step 124 in some embodiments.

In at least some embodiments, the monitoring of system performance in step 314 includes one or more of digital twin deployment, real-time data ingestion, digital twin monitoring, and digital twin retraining and updates.

The digital twin deployment involves deploying the trained digital twin in a simulation program that simulates a use environment such as a production environment that is an industrial plant or a data center. The deployment includes simulation tasks such as packaging the digital twins, integrating the digital twins with a target system, and deploying the digital twins on appropriate hardware and software platforms. Once the digital twin is deployed, the digital twin is able to ingest real-time data from the target system. To achieve this ability of real-time data ingestion, one or more sub-tasks are performed such as setting up one or more data pipelines, establishing data connectivity, and integrating with data storage systems.

In order to ensure the digital twin is performing as expected, in at least some embodiments the performance of a deployed digital twin is monitored and adjustments are made as needed. In some embodiments the monitoring encompasses one or more tasks of setting up monitoring tools and dashboards, tracking digital twin accuracy and performance metrics, and using alerts and notifications to identify and address issues in real-time. Over time, the digital twin may require updates to reflect changes in the target system or to improve performance. In some embodiments, digital twin retraining and updates are performed including by performing subtasks such as retraining pipelines, identifying opportunities for improvement, and integrating updates into the deployed digital twin.

FIG. 4A is another operational flowchart illustrating aspects of data collection and processing steps 400 that according to at least one embodiment are involved in the digital twin refining processes 100 (shown in FIG. 1) and 300 (shown in FIG. 3) described earlier. For example, the data collection and processing steps 400 expand upon the data collection that occurs in steps 104, 110, 118, and/or 304 and elsewhere within the digital twin refining processes 100 and 300. In the data collection and processing steps 400, data is collected in step 402, the data is processed and cleaned in step 404, the data is stored and retrieved in step 406, and the data is visualized and explored in step 408.

In step 402 of data collection and processing steps 400, data is collected. In at least some embodiments, this data collection occurs from various sources such as sensors, Internet-of-Things (IoT) devices, and/or other systems that are used to monitor the physical entity that is being represented via the digital twin. The collected data may also come from digital sensors, digital Internet-of-Things (IoT) devices, and/or other digital systems that are part of a digital twin and capture information from the digital components of the digital twin. The collected data may also come from simulation programs. Some or all aspects of the data collection of step 304 of the other digital twin refining process 300 shown in FIG. 3 applies to step 402.

In step 404 of data collection and processing steps 400, the data is processed and cleaned in step 404. This data that is processed and cleaned in step 404 refers to the data that was collected in step 402. The preprocessing that occurs depends on the data type which depends on the type of physical entity which the digital twin digitally represents. The processing and cleaning helps the data be accurate, consistent, and ready for analysis. The raw data is taken and transformed into a format that is more easily understood by the one or more machine learning models and the one or more simulation programs. The digital twin refinement program 1116 may perform step 404 in an automated manner in response to receiving the raw data. The digital twin refinement program 1116 may analyze the data to determine whether and the extent to which the data transformation for the preprocessing and cleaning needs to occur. The step 404 may occur after data collection in digital twin refining processes 100 and 300 and before further data usage.

In some embodiments, the data processing of step 404 includes clustering via the implementation of one or more clustering algorithms being applied to the data. Clustering algorithms group similar data points together, e.g., from the performance data of a digital twin and/or of a physical entity represented by the digital twin. Outlier data points not part of other data clusters may constitute noise and may be removed and not fed into the machine learning model (e.g., the neural network of the machine learning model) and/or simulation program. The clusters and/or data points that are part of the clusters are input into the various machine learning models.

In some embodiments, the data processing of step 404 includes performing cluster-based feature engineering. A clustering algorithm is applied to the performance data, e.g., of the digital twin or of a physical entity represented by the digital twin. The clustering algorithm identifies clusters in the data points of the performance data. In some embodiments, at least one of the clusters includes an enhanced feature for inputting into the machine learning model. The enhanced feature includes a combination of at least two data types of the performance data of the digital twin and/or of the physical entity represented by the digital twin. The clustering algorithm application can help identify features that are most relevant to the critical task. For example, if the data is generated from various sensors or digital sensors measuring various aspects of the performance of the entity, e.g., of a machine or a digital twin representing the machine, clustering can be used to group the data according to sensors that are more closely related. These similar data/similar sensor groups can be used to create new features that are more informative for the machine learning model and for the neural network of the machine learning model.

FIG. 4B illustrates a data clustering graph 460 that according to at least some embodiments is involved in the digital twin refining processes 100 and 300 described earlier. The data clustering graph includes an x-axis 462, a y-axis 464, and a z-axis 466. The three axes are shown for illustration convenience but the data clustering may include more than three dimensions. In some embodiments the digital twin refinement program 1116 applies a clustering algorithm to the performance data of the digital twin to identify clusters and outliers amongst the data. FIG. 4B shows a first data outlier point 472 which is not part of any data cluster. First, second, third, and fourth data clusters 468a, 468b, 470a, 470b are illustrated in the data clustering graph 460. In some embodiments, the clusters such as the first, second, third, and fourth data clusters 468a, 468b, 470a, 470b are input into a machine learning model for prediction but the outliers such as the first data outlier point 472 are not input into the machine learning model for prediction.

FIG. 4B also shows that the third and fourth data clusters 470a, 470b are a respective combined data cluster formed as a combination of at least two data types of the performance data. The third data cluster 470a is shown as a combination of a first data type indicated as the solid circle and of a second data type indicated with “X”. The fourth data cluster 470b is shown as a combination of the first data type indicated as the solid circle and of another data type indicated with “Y”. The digital twin refinement program 1116 may recognize that in the combined data clusters constitute an enhanced feature for inputting into the machine learning model.

In step 406 of data collection and processing steps 400, the data is stored and retrieved. The data stored in step 406 refers to the data collected in step 402 and/or to the data that was cleaned in step 404. The data may be stored in computer memory that is accessible to and/or part of the digital twin refinement program 1116. For example, the data may be stored in the persistent storage 1113 that is part of the client computer and/or in data storage that is part of the remote server 1104 shown in FIG. 11. When new steps of the digital refining processes 100 and/or 300 occur, necessary data for inputting to a machine learning model and/or to a simulation program may be retrieved from the data storage for usage at the appropriate step. The step 406 may occur after data collection in digital twin refining processes 100 and 300 and before further data usage.

In step 408 of data collection and processing steps 400, the data is visualized and explored in step 408. The data refers to the stored data from step 406 and/or to other data from the data collection and processing steps 400. The visualization and exploration of the data of step 408 facilitates the identification of trends, patterns, and/or anomalies in the data. Machine learning models, automated analysis programs, and/or data experts may be used to explore the data in step 408. The data may be presented visually and/or audibly as part of step 408. In some embodiments, the generation and use of a state transition version graph as depicted in FIG. 10 is part of data visualization of step 408. The exploration of the data in at least some embodiments includes statistical analysis performed in an automated manner via the digital twin refinement program 1116. The step 408 may occur as part of steps 304, 306, and 120 and elsewhere within the digital twin refining processes 100 and 300. Some embodiments of step 408 include for the exploration of data in step 408 one or more of statistical analysis, machine learning, model validation, and integration with other tools. The data analytics and modelling may be integrated with other tools used in the development and deployment process such as version control systems, simulation tools, and optimization tools.

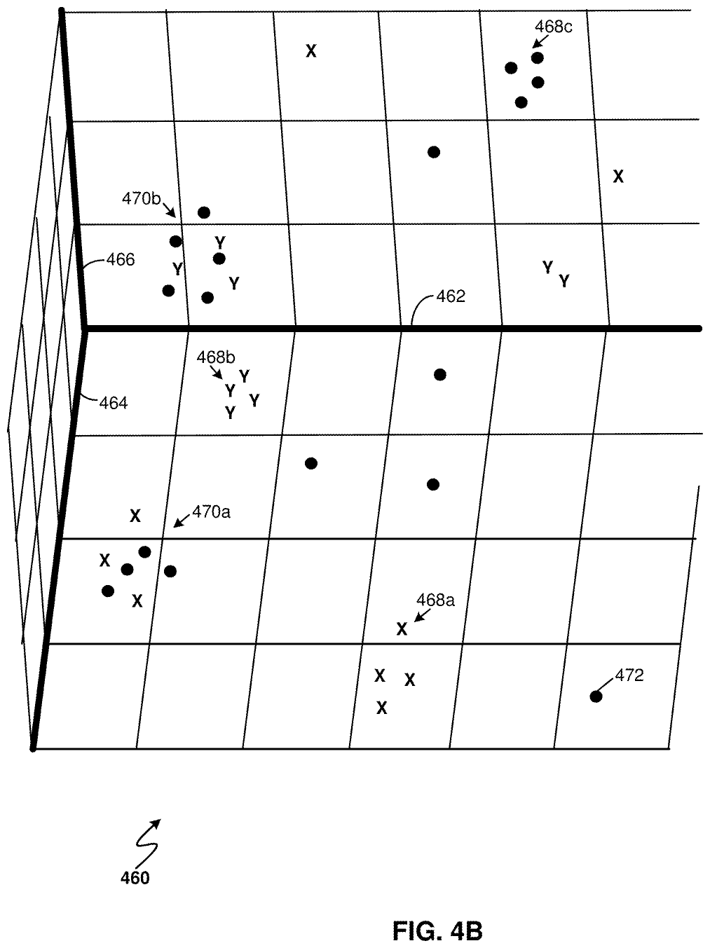

FIG. 5 is another operational flowchart illustrating aspects of a data analytics and modelling process 500 that according to at least one embodiment is involved in the digital twin refining processes 100 and 300 described earlier. In the data analytics and modelling process 500, historical data is collected in step 502, feature engineering is performed in step 504, a data record is vectorized in step 506, clustering is performed in step 508, labeling of identified clusters is performed in step 510, and a labeled history data record is created in step 512. The feature engineering of step 504, the vectorizing of a data record in step 506, the clustering of step 508, the labeling of step 510, and the data record creation of step 512 may be part of data collection and/or the data preprocessing that are part of steps 402 and 404, respectively, of the data collection and preprocessing steps 400 that were shown in FIG. 4A. The historical data collected in step 402 may be used to train the machine learning model and/or to build a simulation program.

In at least some embodiments, the labeling of identified clusters in step 510 and the creation of a labeled history data record in step 512 are performed in an automated manner via the digital twin refinement program 1116. In other embodiments the labeling of identified clusters in step 510 and the creation of a labeled history data record in step 512 are performed in a semi-automated manner with the digital twin refinement program 1116 generating a graphical user interface to solicit feedback and/or input from a field engineer knowledgeable about the entity field and labeling. In at least some embodiments, the creation of the labeled history data record includes the digital twin refinement program 1116 automatically setting a confidence score for every data record and automatically setting a performance a metric index for every data record.

In the embodiment in which the physical entity is a temperature control system as depicted in FIG. 2, the historical data collected for step 502 includes collecting one or more of historical data related to ambient temperature, air conditioning set temperature, air conditioning power requirements, number of air conditioners for the location/system, distance between the air conditioners, the power supply (design, power output, etc.), the number of temperature sensors, the respective space distance between the temperature sensors, the number of air quality sensors, the respective space distance between the air quality sensors, the personnel density, and the device density. Based on the historical data, an extreme case may be generated based on historical data and on common sense for a person skilled in this field. Based on this temperature control system, the machine learning model may generate various system/digital twin modification suggestions such as adding, moving, and/or removing one or more components of the system, modifying an aspect of the system environment such as by adding insulation materials, making an internal change such as modifying an internal aspect of a component of the system, a reorganization of the components of the system and/or a combination of one of the above-mentioned possibilities.

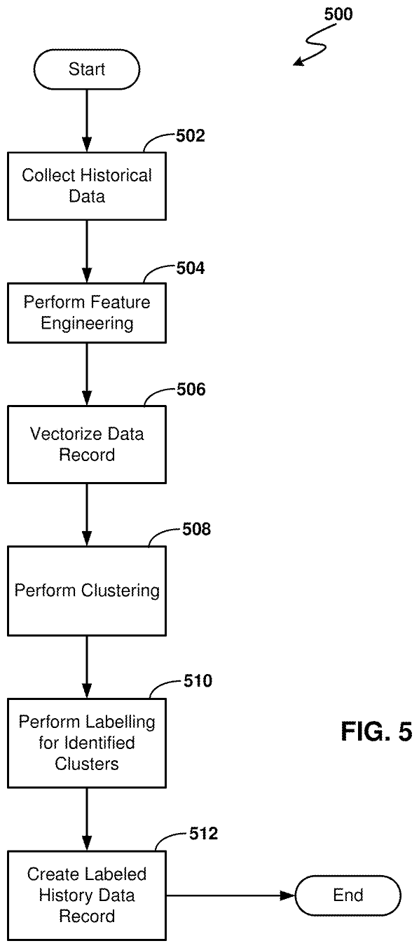

FIG. 6 is another operational flowchart illustrating aspects of a model prediction and refinement loop 600 that according to at least one embodiment is involved in the digital twin refining processes 100 and 300 described earlier. In the model prediction and refinement loop 600, data is prepared in step 602, the data is analyzed in step 604, a model is developed in step 606, the model is validated in step 608, and the model is refined in step 610. Then the model prediction and refinement loop returns to the step 602 for data preparation.

In step 602 of the model prediction and refinement loop 600, collected data is prepared for analysis by performing preprocessing such as cleaning the data to remove any errors or inconsistencies, normalizing the data to ensure that the data is comparable across different entities, and selecting relevant features that can be used to predict changes in the digital twins and/or physical entities. The data preparation of step 602 shares features with the processing and cleaning of data that occurs in step 404 of the steps 400 shown in FIG. 4. The data preparation of step 602 is performed automatically via the digital twin refinement program 1116 in response to the reception or partial reception of the collected data.

In step 604 of the model prediction and refinement loop 600, with the data prepared a data analysis phase begins. The data analysis in some embodiment uses statistical techniques such as regression analysis and/or time-series analysis to identify trends and patterns in the cleaned data. The digital twin refinement program 1116 performs such data analysis automatically in response to completion or partial completion of the data cleaning of step 602. Alternatively or additionally, the digital twin refinement program 1116 uses machine learning algorithms such as neural networks or decision trees to identify patterns and make predictions from the data. The data analysis of step 604 shares at least some features with the data analysis of step 304 of the other digital twin refining process 300 shown in FIG. 3.

In step 606 of the model prediction and refinement loop 600, patterns that were identified in the data in step 604 are used to develop models that can be used to predict new versions of digital twins and, therefore, new versions of physical entities that are represented by the digital twins. In at least some embodiments, these models are machine learning models and include one or more of neural networks, mathematical equations, decision trees, and other types of algorithms that can be used to make predictions. Thus in this embodiment, data from the physical entity and/or its digital twin are used to build the machine learning model for predicting a change for the digital twin to improve the digital twin. This embodiment represents an alternate feature to the machine learning model building of step 102 in the digital twin refining process 100 of FIG. 1 (in which respective evolved families of one or more other physical entities are used to train the machine learning model). These features with entity-specific data used to train the machine learning model alternatively are added to boost the machine learning model training of step 102 that occurs with digital twins from other physical entities.

In step 608 of the model prediction and refinement loop 600, the one or more models developed in step 606 are validated to ensure that the one or more models accurately and reliably generate modification suggestions for improving the digital twin and the physical entity represented by the digital twin. In at least some embodiments this validation includes testing the machine learning models on historical data and/or historical digital twins to see how well the machine learning models predict changes that have already occurred. The validation also alternatively or additionally includes using the models to make predictions on new data and comparing these predictions to the actual changes that occur. In at least some embodiments, this validation of step 608 is performed automatically via the digital twin refinement program 1116 upon receiving a newly built machine learning model.

In step 610 of the model prediction and refinement loop 600, the validated machine learning model is further refined by using new data that becomes available. This refining helps the machine learning models remain accurate and up to date. In at least some embodiments the refining includes retraining the one or more machine learning models with new data and/or tweaking the one or more machine learning models to reflect changes in the entities that were not captured by the original models. This further refinement is in some embodiments performed via the digital twin refinement program 1116. The further refining of step 610 may include some or all of the various loops and loopbacks described earlier for the other drawings.

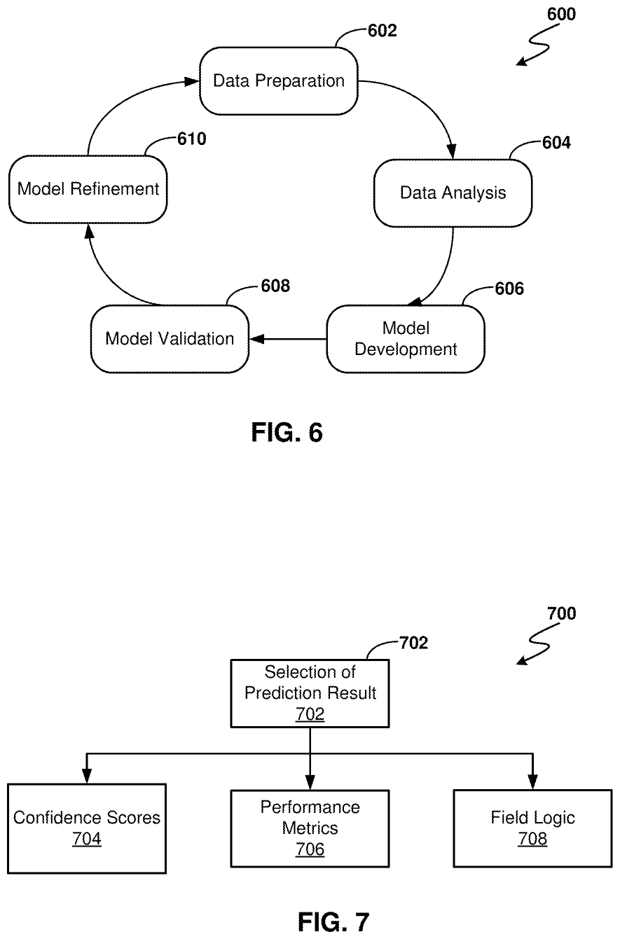

FIG. 7 illustrates a model output selection process 700 which according to at least one embodiment is involved in the digital twin refining processes 100 and 300 described earlier and used in the model prediction and refinement loop 600 described above and in other aspects of the disclosure. In the model output selection process 700, in step 702 a selection of prediction result occurs, in step 704 confidence scores are evaluated, in step 706 performance metrics are evaluated, and in step 708 field logic is evaluated. In some embodiments the machine learning model produces multiple possible changes. Each change is evaluated under at least one of steps 702, 704, and 706 for confidence scores, performance metrics, and field logic, respectively. In some instances, the field logic incorporates aspects of business analysis related to the use of physical entity. The performance metrics from step 706 may be produced via entering the model into a simulation program. The confidence scores may be based on internal weights of the machine learning model and may be affected by historical field knowledge of the entity used to refine the machine learning model. Based on one or more of these three evaluations the selection occurs in step 702. In at least some embodiments, a change/changed digital twin with a highest confidence score, with highest performance metrics, and/or a highest rating for field logic is selected as the change in step 702. In some embodiments, the three evaluation scores are averaged and compared to the averages of the other possible changes to determine the selection, with the change(s) with the highest average score being selected. In some embodiments, based upon the second digital twin having a highest confidence score, the first machine learning model selects the second digital twin amongst multiple proposed digital twins for output in response to the inputting.

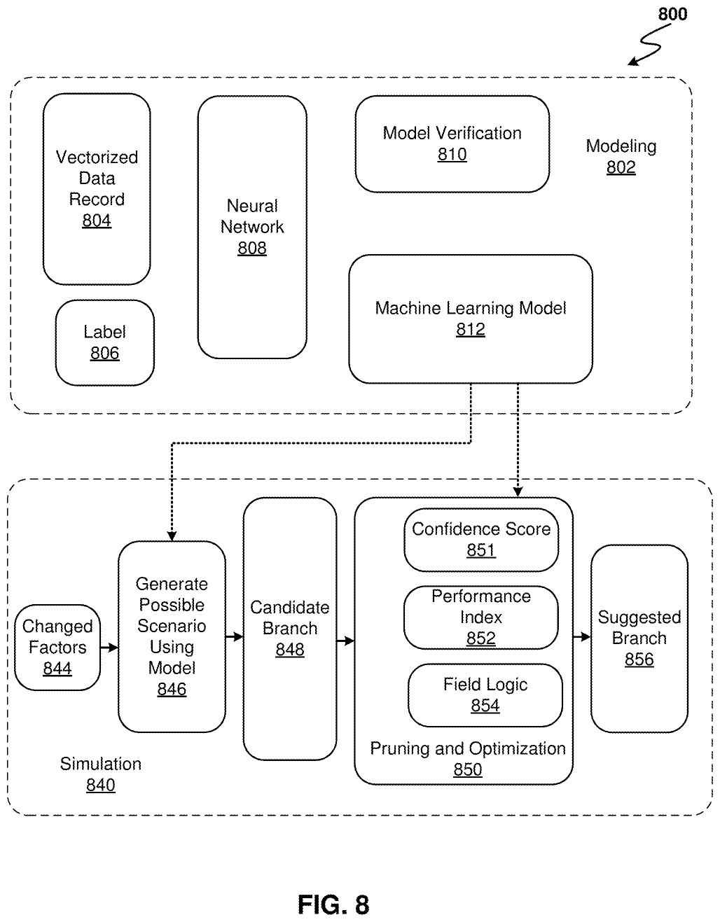

FIG. 8 is a pipeline illustrating a modelling and simulation interaction pipeline 800 that according to at least one embodiment is involved in the digital twin refining processes 100 and 300 and related processes described earlier. The modelling and simulation interaction pipeline 800 includes a modelling pipeline 802 and a simulation pipeline 840 and illustrates their sub-components and their interactions.

The modelling pipeline 802 includes a vectorized data record 804 and a respective label 806 for the vectorized data record which are submitted/input to a neural network 808 of a machine learning model. For the digital twin refining process 100 of FIG. 1, additionally or alternatively an evolved family of entities is input into the neural network 808 to produce the machine learning model 812. The neural network 808 is trained to make the machine learning model 812 whose predictions for digital twin change and refinement can be verified via simulation that can occur in the simulation pipeline 840. The model verification stage 810 includes the trained machine learning model 812 interacting with the simulation pipeline 840.

The simulation pipeline 840 includes a component of changed factors 844 being forwarded to stage 846 for generating a possible scenario using the trained machine learning model 812 from the modelling pipeline 802. The changed factors may include aspects learned from entity changes from other evolved entity families which were used to train the machine learning model 812. After stage 846, in stage 848 a candidate branch is produced via the trained machine learning model 812. The candidate branch is input into a pruning and optimization module 850 of the digital twin refinement program 1116. The pruning and optimization module 850 determines and evaluates a confidence score 851, a performance index, 852, and/or field logic 854 to evaluate the quality of the candidate branch. This aspect of the pruning and optimization module 850 shares features with the model output selection process 700 shown in FIG. 7 and described earlier. Based on the candidate branch passing an evaluation performed via the pruning and optimization module 850, the candidate branch becomes a suggested branch 856 for use to update the digital twin to produce a changed digital twin.

Some embodiments include the further optimization and refinement of a changed digital twin that was suggested by the machine learning model. In at least some embodiments, the further optimization and refinement includes the implementation of one or more of optimization algorithms, refinement algorithms, experiment design, performance monitoring, feedback mechanisms, and integration with other tools.

In some embodiments, the optimization algorithm(s) provides the ability to optimize the behavior of the digital twin and the physical entity represented by the digital twin based on various objectives and constraints. The refinement algorithm(s) provide the ability to refine the machine learning model, the digital twin, and/or the physical entity represented by the digital twin based on the simulation results and feedback from users. Experimental design may be performed in an automated manner via the digital twin refinement program 1116 and enables the creation and testing of different experiments and scenarios. This experimental design allows users to evaluate the impact of different factors and possible adjustments on the performance of the digital twin and the physical entity being represented by the digital twin.

In some embodiments the performance monitoring is performed via the digital twin refinement program 1116 and provides the ability to monitor the performance of the digital twin and/or the physical entity that is represented by the digital twin. Metrics such as accuracy, efficiency, and reliability are collected, determined, and/or gathered to monitor the performance. In some embodiments, feedback mechanisms are included in the digital twin refinement program 1116 and enable users to provide feedback on the performance of the digital twin and/or the physical entity that is represented via the digital twin. The digital twin refinement program 1116 generates a prompt such as a graphical user interface prompt to display a solicitation for user feedback. The feedback mechanism helps facilitate continuous improvement and refinement over time of the machine learning model and the digital twin. Integrating the digital twin refinement program 1116 and its optimization and refinement modules with other tools used in the development and deployment process allows wider usage and implementation of the digital twin refinement program 1116. In some embodiments the digital twin refinement program 1116 and its optimization and refinement modules are integrated with other tools such as version control systems, simulation tools, and data collection and analysis tools.

In at least some embodiments, the further optimization and refinement of a changed digital twin that was suggested by the machine learning model includes the implementation of one or more of a modelling and simulation engine, data management, scenario creation and testing, visualization and analysis, and optimization and machine learning.

In at least some embodiments, the modelling and simulation engine is part of the digital twin refinement program 1116, is a core of the simulation tool, and is a software module. The modelling and simulation engine provides the ability to create one or more simulation programs which can simulate operation for a digital twin that represents a physical entity. The simulation program simulates the behavior of the digital twin based on various inputs and conditions. In at least some embodiments, the data management is performed via the digital twin refinement program 1116 and enables the simulation tool to manage and organize the data that is used in the modelling and simulation process. This data includes data from the digital twin, from the physical entity itself, and/or from external sources.

In at least some embodiments, the digital twin refinement program 1116 performs scenario creation and testing to create and test different scenarios and conditions for the digital twin and the physical entity that is represented by the digital twin. The scenario creation and testing enables users to test the impact of different factors on the behavior of the digital twin. In at least some embodiments, the digital twin refinement program 1116 performs visualization and analysis which enables the simulation results to be visualized and analyzed. The visualization and analysis allows users to gain insights into the behavior of the digital twin and identify areas for improvement. In at least some embodiments, the digital twin refinement program 1116 performs optimization and machine learning to optimize the behavior of the digital twin and the physical entity based on the simulation results. The machine learning algorithms learn from the data and improve the accuracy of the simulations over time.

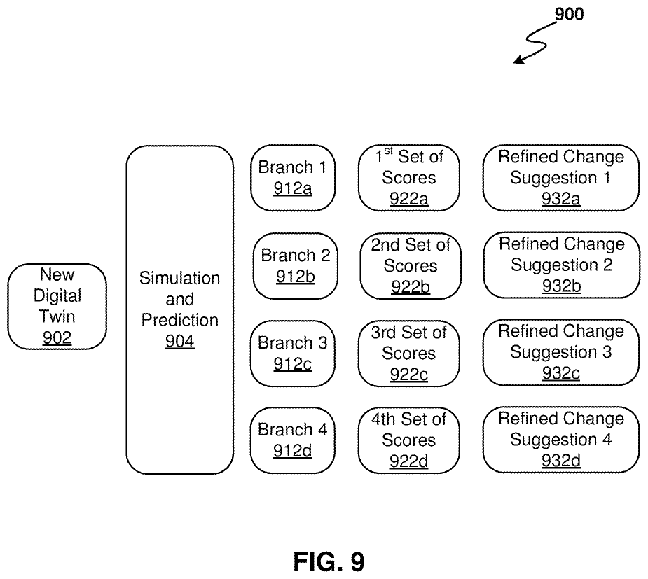

FIG. 9 illustrates an optimization and refinement pipeline 900 illustrating aspects of digital twin optimization and refinement that according to at least one embodiment are involved in the digital twin refining processes 100 and 300 described earlier. In the optimization and refinement pipeline 900, a new digital twin 902 is provided to the simulation and prediction stage 904. The simulation and prediction stage 904 produces a variety of suggestions for improving the new digital twin 902. The suggestions are separated into first, second, third, and fourth branches 912a, 912b, 912c, and 912d, respectively. Each of the various branches included a respective refined change suggestion such as the first refined change suggestion 932a, the second refined change suggestion 932b, the third refined change suggestion 932c, and the fourth refined change suggestion 932d for the first, second, third, and fourth branches 912a, 912b, 912c, and 912d, respectively. Evaluation was performed by the digital twin refinement program 1116 in an automated manner on each of the first refined change suggestion 932a, the second refined change suggestion 932b, the third refined change suggestion 932c, and the fourth refined change suggestion 932d to produce respective sets of evaluation scores including a 1^{st} set of scores 922a, a 2^{nd} set of scores 922b, a 3^{rd} set of scores 922c, and a 4^{th} set of scores 922d for the first, second, third, and fourth refined change suggestions 932a, 932b, 932c, and 932d, respectively. In some embodiments, the set of scores includes numerical ratings, e.g., based on a scale of 0 to 100 with 0 being a worst score and 100 being a highest score. Based on these scores, the digital twin refinement program 1116 chooses a suggestion for implementing the digital twin. In at least some embodiments, the digital twin refinement program 1116 chooses the suggestion with the best set of evaluation scores, e.g., with the highest averaged scores across the set.

In the example with the temperature control system 200 that was illustrated in FIG. 2, the various suggestions for the optimization and refinement pipeline 900 amongst the various branches included improving the working power of an air conditioner as the first refined change suggestion 932a, changing the location of an air conditioner as the second refined change suggestion 932b, adding a new additional air conditioner as the third refined change suggestion 932c, and re-organizing the equipment as the fourth refined change suggestion 932d. The 1st set of scores 922a for improving the working power of an air conditioner included a confidence score of 98 and a performance index score of 93 (both on scales of 0 worst to 100 best) for an average score of 95.5. The 2nd set of scores 922b for changing the location of the air conditioner included a confidence score of 89 and a performance index score of 100 (both on scales of 0 worst to 100 best) for an average score of 94.5. The 3rd set of scores 922c for adding a new air conditioner included a confidence score of 97 and a performance index score of 80 (both on scales of 0 worst to 100 best) for an average score of 88.5. The 4th set of scores 922d for re-organizing the equipment included a confidence score of 95 and a performance index score of 95 (both on scales of 0 worst to 100 best) for an average score of 95. Thus, in some embodiments based on evaluating the average score the first refined change suggestion 932a would be automatically selected via the digital twin refinement program 1116 due to having a set of scores with an average (95.5) that is higher than the other choices. Thus, in at least some embodiments one or more changes for a changed, e.g., second, digital twin are selected from a group consisting of a change of an operating condition of a previous, e.g., first, digital twin, a change of location of one or more elements of the previous, e.g., first, digital twin, an addition of one or more new elements that are not present in the previous, e.g., first, digital twin, and a removal of one or more elements of the previous, e.g., first, digital twin.

In some embodiments, the selection and evaluation illustrated in FIG. 9 is implemented via the machine learning model, e.g., in step 114 of the digital twin refining process 100 shown in FIG. 1. In some embodiments, the selection and evaluation illustrated in FIG. 9 is implemented via a refinement loop performed in response to a negative assessment at step 120 in the digital twin refining process 100 shown in FIG. 1. In some embodiments, the selection and evaluation illustrated in FIG. 9 is implemented via refining of the changed version in step 310 of the other digital twin refining process 300 shown in FIG. 3.

FIG. 10 illustrates a state transition version graph 1000 of various digital twins which according to at least one embodiment is involved in the digital twin refining processes 100 and 300 and other processes described earlier. The various digital twins are represented in the state transition version graph 1000 with a respective symbol such as a circle. Therefore, a respective symbol is provided on the state transition version graph 1000 for each different digital twin version in the digital twin version history for a respective base entity. For example, one state transition version graph 1000 shows different versions of a respective base entity that namely is a temperature control system, a building, a manufactured object, etc. The state transition version graph 1000 in some embodiments includes a symbol representing a first digital twin, a second digital twin, a third digital twin, and one or more additional digital twins. An initial digital twin circle 1002 that represents a digital twin that is initially generated or received (e.g., in step 106 or step 302) is shown in the upper left of the state transition version graph 1000. Using the methods and digital twin refinement program 1116 described herein, the machine learning model generates multiple potential changed digital twins (represented by the other circles in FIG. 10) for the digital twin represented by the initial digital twin circle 1002. These possible changed digital twins are represented by other circles displayed on the state transition version graph 1000. A first branch 1004 of digital twin representations is shown and includes three digital twin versions including the initial digital twin circle 1002. Three other branches of digital twin representations are also shown in FIG. 10. The four different branches are distinguished from each other in the state transition version graph 1000 shown in FIG. 10 via differing interior symbols within the respective circle. The members of the first branch 1004 have an X as an interior symbol. The members of the second branch have a + as an interior symbol. The members of the third branch have a single vertical line as an interior symbol. The members of the fourth branch have a single horizontal line as an interior symbol.

The rightward pointing connecting arrows in the state transition version graph 1000 of FIG. 10 indicate a transition from one digital twin to a changed digital twin based on the previous iteration of the digital twin at the beginning of the particular connecting arrow. A first forward transition 1006 is labeled in FIG. 10.

The leftward pointing connecting arrows in the state transition version graph 1000 of FIG. 10 have a dotted line form and indicate a rollback action from a changed digital twin to a previous version of a digital twin. Such rollback occurs when simulations indicate that the changed digital twin would cause problems for the digital twin/physical entity so that the new digital twin needs to be revoked and/or blocked from implementation. A first rollback 1008 is labelled in FIG. 10. The rollback dotted line indicates that the digital twin version at the end of the dotted line (e.g., by the arrowhead) is reimplemented once the troublesome digital twin version is revoked.

In some embodiments, in response to the determination that a changed digital twin is problematic (e.g., an affirmative determination in step 120 in the digital twin refining process 100 shown in FIG. 1) the state transition version graph 1000 is automatically consulted via the digital twin refinement program 1116 to determine a suitable alternative digital twin version to which the installed digital twin will roll back. In some embodiments, navigation through the state transition version graph 1000 is performed to select another digital twin version to reimplement in response to the revoking of a problematic digital twin. In some embodiments the navigation is performed automatically via the digital twin refinement program 1116 to achieve the selection. In some embodiments the navigation is performed semi-automatically based on the digital twin refinement program 1116 receiving input from a user in order to achieve the selection. The current installed version of the digital twin is identified, e.g., by finding metadata associated with the installed digital twin. The found metadata is used in a search through various digital twin representations of the state transition version graph 1000 until a match is found. In some embodiments, some or all of the digital twin representations (the various circles on the state transition version graph 1000) include metadata associated with the particular digital twin which the respective circle represents. In some embodiments, a selection of which earlier digital twin to rollback to is made in an automated manner via the digital twin refinement program 1116. In some embodiments, a selection of which earlier digital twin to rollback to is made in a semi-automated manner via the digital twin refinement program 1116 generating a prompt to ask a user to select another digital twin representation displayed in the state transition version graph 1000. The state transition version graph 1000 represents a version history for a version control system. For the semi-automated selection, the program and the prompt allow the user to scroll and/or navigate through the circles of the state transition version graph 1000 to move a cursor to a particular circle/digital twin. Another actuation can cause selection of the circle at which the cursor currently lies. In an automated selection the digital twin refinement program 1116 may prefer nearest circles in the state transition version graph 1000, e.g., a nearest circle within the same branch or other nearby circles from adjacent branches.

In at least some embodiments, the state transition version graph 1000 implements the version labeling principles so that a digital twin version label is displayed and/or associated with the respective circle/symbol that represents that digital twin version. The use of version labels makes the changes easier to track and manage. The state transition version graph 1000 helps provide a version history which tracks the changes made to each version of the digital twin. This tracking helps enable users to review the history of the digital twins and understand how the digital twins have evolved over time. For example, in some embodiments after the changes are identified in step 306 the changes are displayed at and/or associated with the respective symbol (e.g., circle) representing the particular digital twin. The display of branches within the state transition version graph 1000 and merging of branches enables multiple versions of the digital twin to be managed and maintained in parallel. In some embodiments, the digital twin refinement program 1116 allows merging of changes between the digital twins of different branches. For example, certain features from a changed digital twin of a second branch are added to a new changed digital twin of a third branch. The state transition version graph 1000 facilitates rollback and recovery if a previous digital twin is to be restored due to issues or performance problems (not meeting expectations) of a new changed digital twin. In some embodiments the digital twin refinement program 1116 also implements access controls with software security to the various versions of the digital twins. The access control controls who has access to each version of the digital twins and ensures that users are authorized before being allowed to view, modify, and/or deploy the digital twin refinement program 1116 and particular digital twins within the state transition version graph 1000. In some embodiments the digital twin refinement program 1116 also generates notifications and alerts to indicate to associated users and/or team members when new changed versions of a digital twin are released, when issues are detected, and/or when important milestones are reached in the development process. Thus, in some embodiments navigating a state transition version graph for selecting a digital twin version to reimplement includes selecting a nearest digital twin symbol along a branch of the digital twin that is to be revoked and selecting a digital twin symbol from another branch next to a branch of the digital twin that is to be revoked.

In response to the selection of a rollback digital twin version, the rollback digital twin version is reimplemented for the installed digital twin and creation of another changed digital twin version is begun. The changed digital twin version is based on the installed digital twin version to which the rollback occurred. The changed digital twin version may include any necessary modifications to bring the previous iteration up to date with recent updates to the various installed digital twins. After a new changed version is created, the new changed version may be tested to evaluate its effectiveness. Simulation tests and/or deployment of the changed digital twin in a test environment may be used to perform the testing. If the new changed digital twin passes the simulation test, the new changed digital twin is reimplemented as the installed version for a main account. The reimplementation may include updating the metadata associated with the digital twin and the physical entity, as well as updating any code and/or configuration files that reference the installed digital twin and/or physical entity.

It may be appreciated that FIGS. 1-10 provide only illustrations of certain embodiments and do not imply any limitations with regard to how different embodiments may be implemented. Many modifications to the depicted embodiment(s), e.g., to a sequence of steps or components that are depicted, may be made based on design and implementation requirements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1100 shown in FIG. 11 contains an example of an environment for the execution of at least some of the computer code involved in performing the inventive methods, such as digital twin refinement 1116. In addition to digital twin refinement 1116, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and digital twin refinement 1116, as identified above), peripheral device set 1114 (including user interface (UI) device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 11. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in digital twin refinement 1116 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, volatile memory 1112 is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface-type operating systems that employ a kernel. The code included in digital twin refinement 1116 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections. Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing exceptionally large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN 1102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101) and may take any of the forms discussed above in connection with computer 1101. EUD 1103 typically receives helpful and useful data from the operations of computer 1101. For example, in a hypothetical case where computer 1101 is designed to provide a natural language processing result to an end user, this result would typically be communicated from network module 1115 of computer 1101 through WAN 1102 to EUD 1103. In this way, EUD 1103 can display, or otherwise present, the result to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for digital twin usage, the method comprising:
inputting a first digital twin and performance data of the first digital twin into a first machine learning model that performs neural network-based data clustering to produce a second digital twin, the first and second digital twins digitally representing a first physical entity, the second digital twin comprising one or more changes from the first digital twin;
analyzing performance data of the second digital twin; and
in response to the analysis indicating a problem with the second digital twin, revoking implementation of the second digital twin and reimplementing the first digital twin.

2. The method of claim 1, further comprising inputting the second digital twin and performance data of the second digital twin into the first machine learning model to produce a third digital twin, the third digital twin digitally representing the first physical entity, the third digital twin comprising one or more changes from the second digital twin.

3. The method of claim 2, analyzing performance data of the third digital twin; and
in response to the analysis of the performance data of the third digital twin indicating a problem with the third digital twin, revoking implementation of the third digital twin and reimplementing the second digital twin.

4. The method of claim 2, further comprising:
producing, via the first machine learning model, one or more additional digital twins comprising a respective digital representation of the first physical entity;
producing a state transition version graph representing the first, the second, the third, and the one or more additional digital twins;
analyzing performance data of the third digital twin; and
in response to the analysis of the performance data of the third digital twin indicating a problem with the third digital twin, revoking implementation of the third digital twin and implementing another of the first, second, and one or more additional digital twins, wherein selecting of the other digital twin for the implementing is based on navigating the state transition version graph.

5. The method of claim 4, wherein the navigating comprises at least one member selected from a group consisting of selecting a nearest digital twin symbol along a branch of the third digital twin and selecting a digital twin symbol from another branch next to a branch of the third digital twin.

6. The method of claim 1, wherein, based upon the second digital twin having a highest confidence score, the first machine learning model selects the second digital twin amongst multiple proposed digital twins for output in response to the inputting.

7. The method of claim 1, further comprising transmitting an alteration command to alter the first physical entity to match the second digital twin.

8. The method of claim 7, further comprising:
generating performance data of the second digital twin via inputting of the second digital twin to a simulation program; and
validating the performance data produced by the simulation program by comparing the performance data of the second digital twin to performance data of the first physical entity that was altered to match the second digital twin.

9. The method of claim 1, further comprising applying a clustering algorithm to the performance data of the first digital twin to identify clusters and outliers, wherein the clusters and not the outliers are input into the first machine learning model.

10. The method of claim 1, further comprising applying a clustering algorithm to the performance data of the first digital twin to identify clusters that are input into the first machine learning model, wherein at least one of the clusters comprises an enhanced feature for inputting into the first machine learning model, the enhanced feature comprising a combination of at least two data types of the performance data of the first digital twin.

11. The method of claim 1, further comprising producing the performance data of the first digital twin via inputting of the first digital twin to a simulation program.

12. The method of claim 1, further comprising training the first machine learning model by inputting evolved entity families of other physical entities to an initial machine learning model.

13. The method of claim 1, wherein the performance data of the digital twin includes at least one member selected from a group consisting of digital sensor readings, digital component data, and user feedback.

14. The method of claim 1, wherein the one or more changes are selected from the group consisting of a change of an operating condition of the first digital twin, a change of location of one or more elements of the first digital twin, an addition of one or more new elements not present in the first digital twin, and a removal of one or more elements of the first digital twin.

15. A computer system for digital twin usage, the computer system comprising:
one or more processors, one or more computer-readable tangible storage media, and program instructions stored on at least one of the one or more computer-readable tangible storage media for execution by at least one of the one or more processors to cause the computer system to:
input a first digital twin and performance data of the first digital twin into a first machine learning model that performs neural network-based data clustering to produce a second digital twin, the first and second digital twins digitally representing a first physical entity, the second digital twin comprising one or more changes from the first digital twin;
analyze performance data of the second digital twin; and
in response to the analysis indicating a problem with the second digital twin, revoke implementation of the second digital twin and reimplement the first digital twin.

16. The computer system of claim 15, wherein the program instructions further cause the computer system to input the second digital twin and performance data of the second digital twin into the first machine learning model to produce a third digital twin, the third digital twin digitally representing the first physical entity, the third digital twin comprising one or more changes from the second digital twin.

17. The computer system of claim 16, wherein the program instructions further cause the computer system to:
produce, via the first machine learning model, one or more additional digital twins comprising a respective digital representation of the first physical entity;
produce a state transition version graph representing the first, the second, the third, and the one or more additional digital twins;
analyze performance data of the third digital twin; and
in response to the analysis of the performance data of the third digital twin indicating a problem with the third digital twin, revoke implementation of the third digital twin and implement another of the first, second, and one or more additional digital twins, wherein selecting of the other digital twin for the implementation is based on navigating the state transition version graph.

18. A computer program product for digital twin usage, the computer program product comprising a computer-readable storage medium having program instructions stored thereon, wherein the program instructions are executable by a processor to cause the processor to:
input a first digital twin and performance data of the first digital twin into a first machine learning model that performs neural network-based data clustering to produce a second digital twin, the first and second digital twins digitally representing a first physical entity, the second digital twin comprising one or more changes from the first digital twin;
analyze performance data of the second digital twin; and
in response to the analysis indicating a problem with the second digital twin, revoke implementation of the second digital twin and reimplement the first digital twin.

19. The computer program product of claim 18, wherein the program instructions are further executable by the processor to cause the processor to input the second digital twin and performance data of the second digital twin into the first machine learning model to produce a third digital twin, the third digital twin digitally representing the first physical entity, the third digital twin comprising one or more changes from the second digital twin.

20. The computer program product of claim 19, wherein the program instructions are further executable by the processor to cause the processor to:
produce, via the first machine learning model, one or more additional digital twins comprising a respective digital representation of the first physical entity;
produce a state transition version graph representing the first, the second, the third, and the one or more additional digital twins;
analyze performance data of the third digital twin; and
in response to the analysis of the performance data of the third digital twin indicating a problem with the third digital twin, revoke implementation of the third digital twin and implement another of the first, second, and one or more additional digital twins, wherein selecting of the other digital twin for the implementation is based on navigating the state transition version graph.
